(19) United States
(12) Patent Application Publication
(10) Pub. No.: US 2015/0145767 A1
(43) Pub. Date: May 28, 2015

(54) ELECTRONIC DEVICE AND DISPLAY METHOD

(71) Applicant: Kabushiki Kaisha Toshiba, Tokyo (JP)

(72) Inventor: Shunsuke TAKAYAMA, Tachikawa Tokyo (JP)

(21) Appl. No.: 14/550,710

(22) Filed: Nov. 21, 2014

Related U.S. Application Data
(60) Provisional application No. 61/909,025, filed on Nov. 26, 2013.

(51) Int. Cl. G06F 3/14; G06F 3/0486; G09G 5/00; G06F 3/0481

(52) U.S. Cl. CPC G06F 3/1423; G06F 3/0481; G06F 3/0486; G09G 5/003; G09G 2360/04; G09G 2354/00; G09G 2340/12
USPC 345/156

(57) ABSTRACT

There is provided an electronic device including a first display and a second display, including: a display controller configured to display a first image on the second display and display a second image and the first image superimposed on the second image on the first display; an input receiver configured to receive an operation input with respect to the first image displayed on the first display; and a processor configured to execute a first processing routine based on the operation input received by the input receiver.

### CROSS-REFERENCE TO RELATED APPLICATION(S)

This application claims priority from U.S. Provisional Patent Application No. 61/909,025 filed on Nov. 26, 2013, the entire contents of which are incorporated herein by reference.

### TECHNICAL FIELD

Embodiments according to the present invention relate to an electronic device and a display method.

### BACKGROUND ART

As an application of the display of an electronic device, the screen of the electronic device has been extended by using a plurality of displays to thereby extend the display area thereof, for example. When it is desired to take a look at a horizontally long image, for example, another display is disposed on the left or right side of a base display so that an image is displayed on the integrated screen of these two displays. However, there has not been known any means suggesting how to operate a plurality of (two, for example) screens on a single display.

### BRIEF DESCRIPTION OF THE DRAWINGS

FIG. 1 is a perspective view showing an example of the outward appearance of an electronic device according to an embodiment.

FIG. 2 is a block diagram showing an example of the system configuration of the electronic device according to the embodiment.

FIG. 3 is a perspective view showing an example of the outward appearance of the rear surface display of the electronic device according to the embodiment.

FIGS. 4A and 4B are diagrams showing utilization examples of a dress-up PC according to the embodiment.

FIG. 5 is a diagram showing a utilization example as an extended display used in the embodiment.

FIGS. 6A and 6B are diagrams showing an example of an application for operating the rear surface display side in the embodiment.

FIG. 7 is a flowchart showing the execution method of moving a window to a small-window application, used in the embodiment.

FIG. 8 is a flowchart showing the execution method of respective operations within the small-window application used in the embodiment.

### MODES FOR CARRYING OUT THE INVENTION

Hereinafter, embodiments according to this invention will be explained.

### First Embodiment

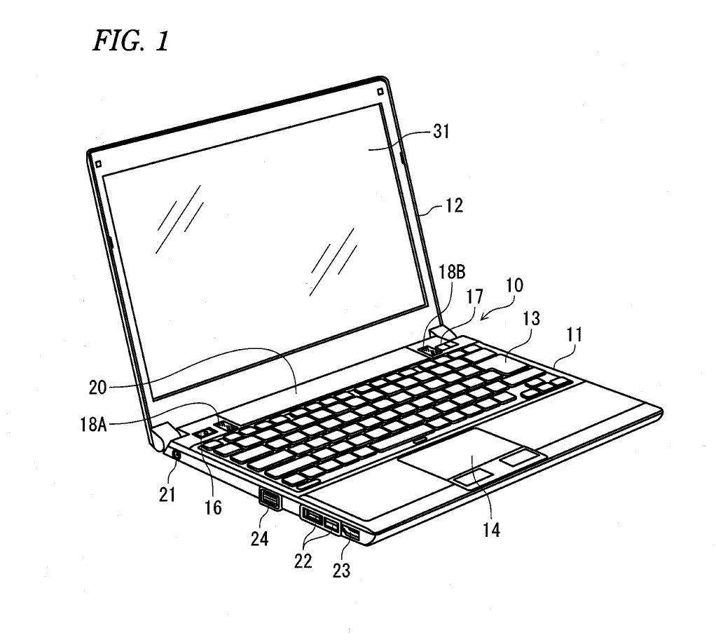

The first embodiment will be explained with reference to FIGS. 1 to 8.

First, the explanation will be made as to the configuration of an electronic device according to the embodiment, with reference to FIGS. 1 to 3. This electronic device can be realized as a notebook-type portable personal computer, a tablet terminal, or one of other various-types of information processing devices, for example.

FIG. 1 is a perspective view of a notebook-type computer 10, seen from the front side thereof, in an opened state of a display unit. The computer 10 is configured to receive electric power from a battery 20. The computer 10 includes a computer main body 11 and a display unit 12. The display unit 12 incorporates therein a display device such as a liquid crystal display device (LCD) 31.

The display unit 12 is attached to the computer main body 11 so as to be freely rotatable between an opened position where the upper surface of the computer main body 11 is exposed and a closed position where the upper surface of the computer main body 11 is covered by the display unit 12. The computer main body 11 has a thin box-shaped casing. On the upper surface of the casing, there are disposed a key board 13, a touch pad 14, a power supply switch 16 for powering ON/OFF the computer 10, functional buttons 17 and speakers 18A, 18B.

The computer main body 11 is provided with a power supply connector 21. The power supply connector 21 is provided on the side surface, for example, the left side surface of the computer main body 11. An external power supply device is connected to the power supply connector 21 so as to be detachable freely. An AC adapter can be used as the external power supply device. The AC adapter is a power supply device for converting commercial power (AC power) into DC power.

The battery 20 is attached to the rear end portion of the computer main body 11, for example, so as to be detachable freely. The battery 20 may be a battery contained within the computer 10.

The computer 10 is driven by the power supplied from the external power supply device or the battery 20. When the external power supply device is connected to the power supply connector 21 of the computer 10, the computer 10 is driven by the power supplied from the external power supply device. Further, the power from the external power supply device is also used for charging the battery 20. During the period where the external power supply device is not connected to the power supply connector 21 of the computer 10, the computer 10 is driven by the power supplied from the battery 20.

Further, the computer main body 11 is provided with some USB ports 22, an HDMI (High-Definition Multimedia Interface) output terminal 23 and an RGB port 24.

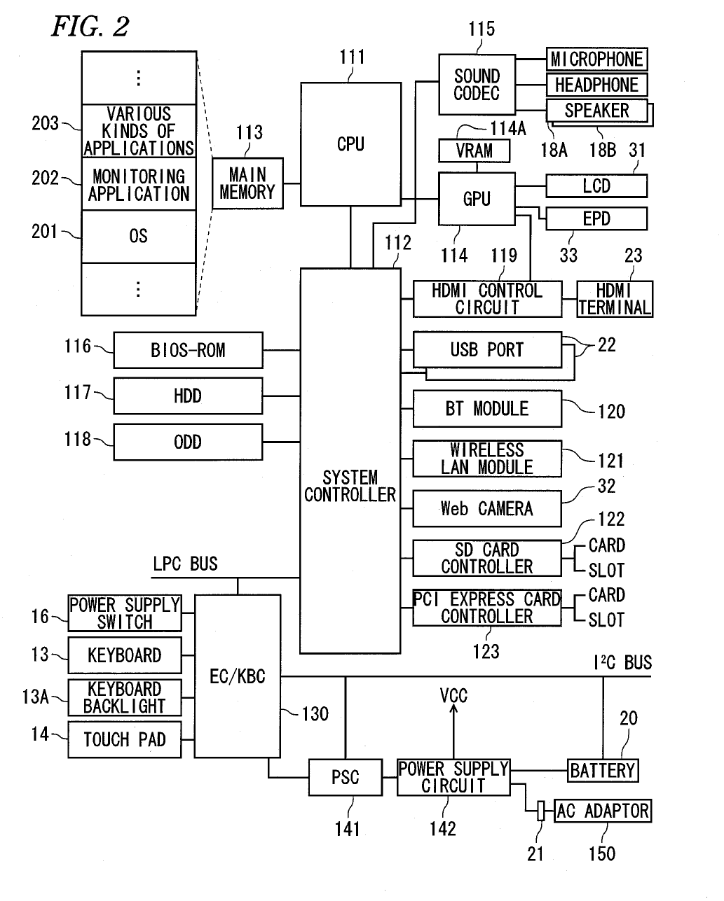

FIG. 2 shows the system configuration of the computer 10. The computer 10 includes a CPU 111, a system controller 112, a main memory 113, a graphics processing unit (GPU) 114, a sound codec 115, a BIOS-ROM 116, a hard disc driver (HDD) 117, an optical disc driver (ODD) 118, a BT (Bluetooth (trade mark)) module 120, a wireless LAN module 121, an SD card controller 122, a PCI EXPRESS card controller 123, an embedded controller/keyboard controller IC (EC/KBC) 130, a keyboard backlight 13A, a power supply controller (PSC) 141, a power supply circuit 142, and so on.

The CPU 111 is a processor for controlling the operations of the respective components of the computer 10. The CPU 111 executes various kinds of softwares loaded to the main memory 113 from the HDD 117. These softwares contain an operating system (OS) 201, monitoring application programs 202 and various kinds of application programs 203. The various kinds of application programs 203 contain the aforesaid desktop related applications and full-screen related applications.

The CPU 111 of the computer 10 executes the monitoring applications 202 as a means for monitoring default applications. The monitoring applications 202 are resident type applications. The monitoring applications 202 monitor the utilization states of the applications executed by the electronic device.

Further, the CPU 111 also executes a basic input/output system (BIOS) stored in the BIOS-ROM 116 as a non-volatile memory. The BIOS is a system program for controlling the hardware.

The GPU 114 is a display controller for controlling the LCD 31 utilized as the display monitor of the computer 10. The GPU 114 generates a display signal (LVDS signal) to be supplied to the LCD 31 based on display data stored in a video memory (VRAM) 114A. Further, the GPU 114 can also generate an analog RGB signal (not shown) and an HDMI video signal based on the display data. The analog RGB signal is supplied to an external display via the RGB port 24. The HDMI output terminal 23 can transmit both the HDMI video signal (uncompressed digital video signal) and a digital audio signal to the external display via a single cable. An HDMI control circuit 119 is an interface for transmitting both the HDMI video signal and the digital audio signal to the external display via the HDMI output terminal 23.

The system controller 112 is a bridge device for connecting between the CPU 111 and the respective components. The system controller 112 contains a serial ATA controller for controlling the hard disc driver (HDD) 117 and the optical disc driver (ODD) 118. The system controller 112 further executes communication with respective devices on an LPC (Low PIN Count) bus.

The EC/KBC 130 is connected to the LPC bus. The EC/KBC 130, the power supply controller (PSC) 141 and the battery 20 are mutually connected via a serial bus such as an 12C bus.

The EC/KBC 130 is a power managing controller for executing the power management of the computer 10. For example, the EC/KBC is realized as an one-chip microcomputer containing a keyboard controller for controlling the keyboard (KB) 13, the touch pad 14, and so on. The EC/KBC 130 has a function of powering ON/OFF the computer 10 in accordance with the operation of the power supply switch 16 by a user. The powering ON/OFF control of the computer 10 is executed by the cooperation of the EC/KBC 130 and the power supply controller (PSC) 141. Upon receiving an ON signal transmitted from the EC/KBC 130, the power supply controller (PSC) 141 controls the power supply circuit 142 to thereby power-ON the computer 10. In contrast, upon receiving an OFF signal transmitted from the EC/KBC 130, the power supply controller (PSC) 141 controls the power supply circuit 142 to thereby power-OFF the computer 10. Each of the EC/KBC 130, the power supply controller (PSC) 141 and the power supply circuit 142 is operated by the power supplied from the battery 20 or an AC adaptor 150 even during a period where the computer 10 is powered-OFF.

Further, the EC/KBC 130 can turn ON/OFF the keyboard backlight 13A disposed on the rear surface of the keyboard 13. Furthermore, the EC/KBC 130 is connected to a panel opening/closing switch 131 configured to detect the opened/closed state of the display unit 12. Even when the opened state of the display unit 12 is detected by the panel opening/closing switch 131, the EC/KBC 130 can power-ON the computer 10.

The power supply circuit 142 generates the power (operation power) to be supplied to the respective components by using the power supplied from the battery 20 or the power supplied from the AC adaptor 150 connected to the computer main body 11 as an external power supply.

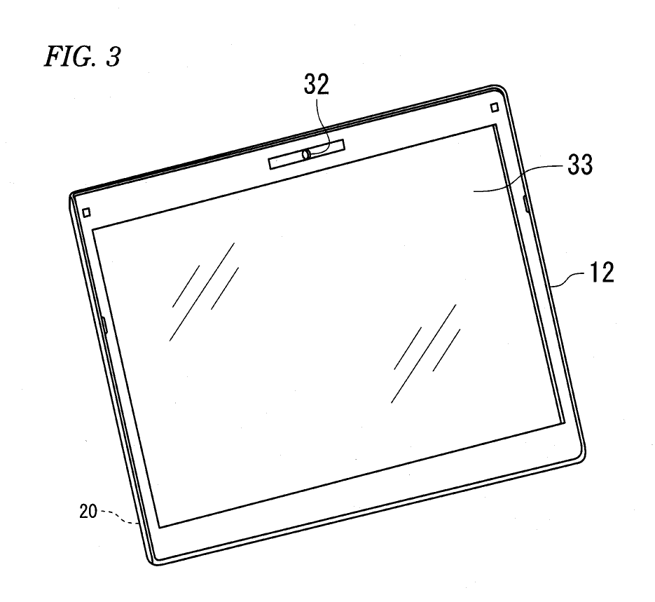

FIG. 3 is a perspective view of the rear surface display portion of the display unit 12 of the notebook-type computer 10, seen from the rear surface side thereof, in the opened state of the display unit. A display device such as an electronic paper display (EPD) 33 is incorporated into the display unit 12. Further, a camera (Web camera) 32 is disposed at the upper end portion of the display unit 12.

As described above, the computer 10 is a notebook PC in which the operating system (OS) 201 is installed, and mounts the liquid crystal display device on the front surface side thereof and the electronic paper display on the rear surface side thereof. The front surface/rear surface displays are recognized by the system as a main display and a sub-display, respectively.

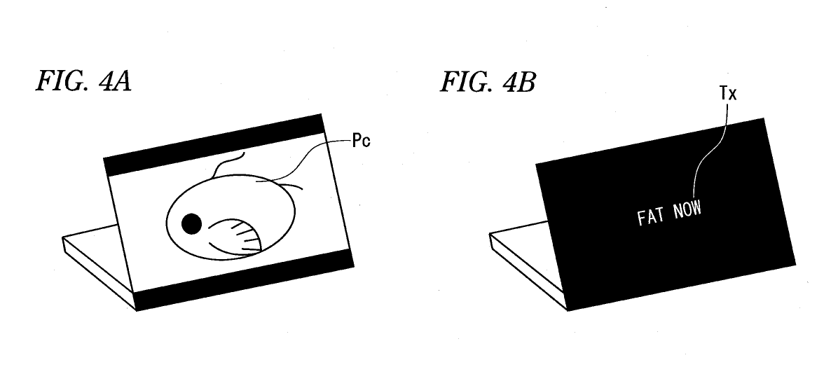

FIGS. 4A and 4B are diagrams showing utilization examples of a dress-up PC according to this embodiment. In FIG. 4A, a picture Pc representing a character is displayed at the rear surface display portion (electronic paper display 33). In FIG. 4B, characters Tx representing “fat now” is displayed at the same rear surface display portion.

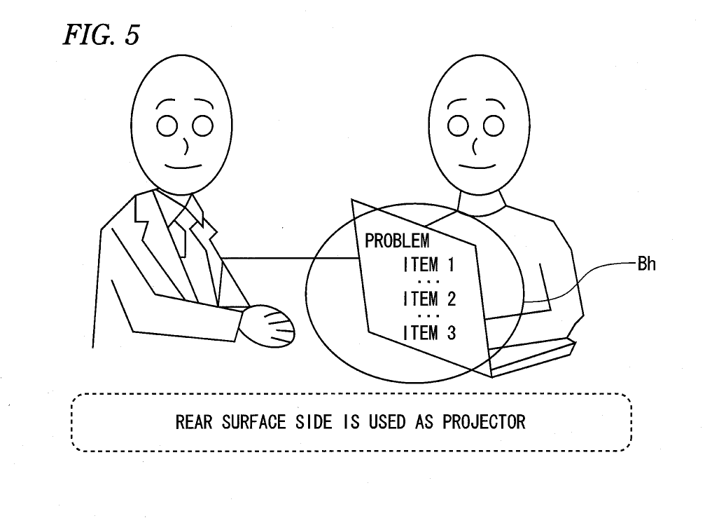

FIG. 5 is a diagram showing a utilization example as an extended display used in the embodiment. A person on the right side in the figure uses the rear surface display side as a projector and shows a projection Bh to a person on the left side in the figure.

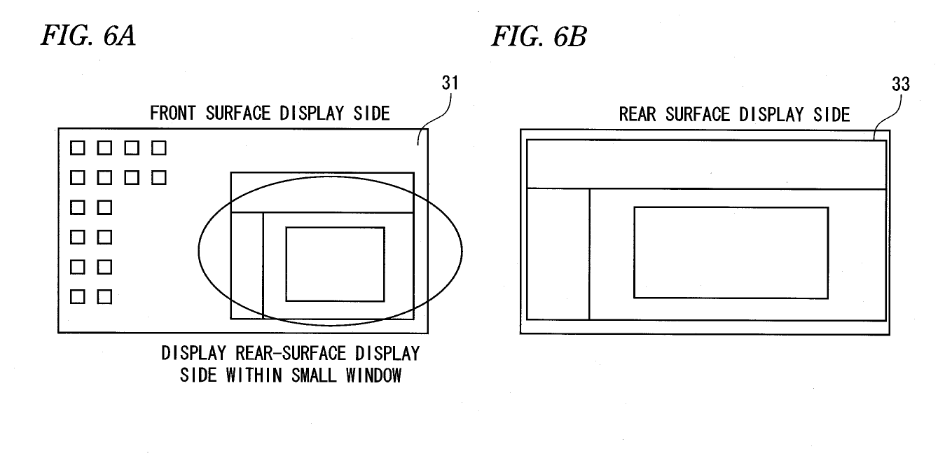

FIGS. 6A and 6B are diagrams showing an example of an application for operating the rear surface display side in the embodiment.

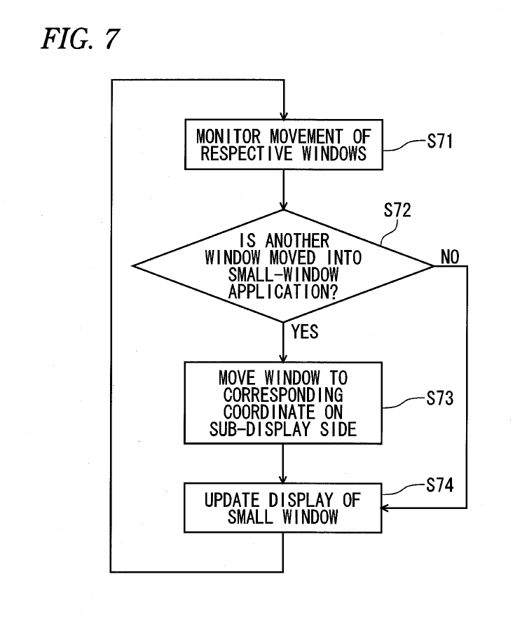

In the desktop screen (front surface display side 31), a small-window application (application program) as one of the monitoring applications 202 is resident. The small-window application always monitors the movement of another window while displaying the rear surface display side within the small window. When a user drags the anther window and drops it within the small-widow application by using the touch pad 14 etc., the window is shown as if the window is moved within the small window. However, in fact, the window is moved to the rear surface display side 33 in the following steps. FIG. 7 is a flowchart showing the execution method of moving the window to the small-window application, used in this embodiment.

Step S71: The CPU 111 monitors the movement of the respective windows.
Step S72: The CPU 111 determines whether or not another window moves within the small-window application. When the determination result is yes, the process proceeds to the next step S73, whilst when the determination result is no, the process proceeds to step S74.
Step S73: The CPU 111 moves the window to a corresponding coordinate on the sub-display side.
Step S74: The CPU 111 updates the display of the small window and the process returns to the step S71.

Further, the process is performed in the following steps with respect to operations such as a click input, a key input so that the windows displayed on the rear surface display side can be operated from the small-window application.

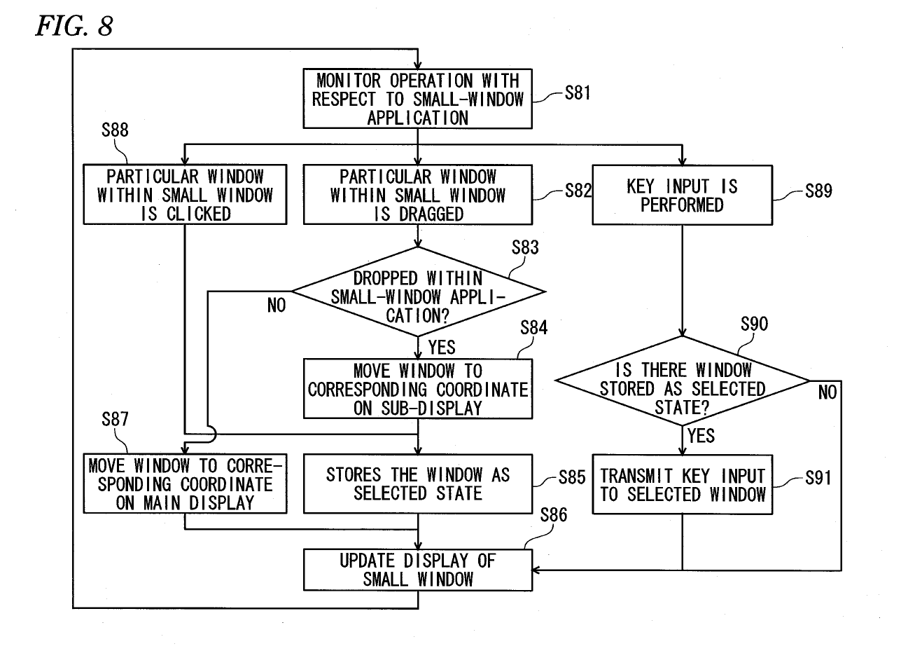

FIG. 8 is a flowchart showing the execution method of respective operations within the small-window application used in this embodiment.

Step S81: The CPU 111 monitors the operation with respect to the small-window application and branches the process to step S82, step S88 or step S89 in accordance with the operation as follows.
Step S82: The CPU 111 confirms that a particular window within the small window is dragged, and the process proceeds to the next step S83.
Step S83: The CPU 111 determines whether or not a coordinate to which the window is dropped belong to the coordinate within the small-window application. When it is determined to belong to the coordinate within the small-window application, the process proceeds to step S84. In contrast, if not, the process proceeds to step S87.
Step S84: The CPU 111 moves the window to the corresponding coordinate on the sub-display.
Step S85: The CPU 111 stores the window as a selected state.
Step S86: The CPU 111 updates the display of the small window and returns the process to the step S81.
Step S87: The CPU 111 moves the window to a corresponding coordinate on the main display, and the process proceeds to the step S86.
Step S88: The CPU 111 confirms that a particular window within the small window is clicked, and the process proceeds to the step S85.
Step S89: The CPU 111 confirms that a key input is performed, and the process proceeds to step S90.
Step S90: The CPU 111 determines whether or not there is a window stored as the selected state. When the determination result is yes, the process proceeds to the next step S91, whilst when the determination result is no, the process proceeds to the step S86.
Step 91: The CPU 111 transmits the key input to the selected window, and the process proceeds to the step S86.

Since the small-window application is required to be always displayed on the front surface display side, when the display is switched between the main display and the sub-display, the small-window application is configured to remain on the front surface display side.

### Second Embodiment

The second embodiment according to this invention will be explained. In this embodiment, explanation about portions common to those of the first embodiment will be omitted.

When a person facing the rear surface display side is away from the display, there is a case that this person is difficult to see the display. Thus, it is preferable to configure that a camera is provided on the rear surface side so as to detect the face of the person, whereby a projection is automatically displayed in a zoom-in state when the distance to the person is long.

The face detection can be performed simply in a manner, for example, that information representing the feature of a face such as eyes, nose, mouth is stored in advance, and a portion within an image having been imaged which coincides with these features is detected as the face.

For example, a not-shown face detection portion detects the face from an image imaged by the camera 23 and specifies the position thereof. Then, the face detection portion specifies the position of the face, to be more concrete, the positions on the x-axis and y-axis of the center position of the face and a distance z from the rear surface display, as the position (x, y, z) of the face of a viewer. The distance z from the rear surface display can be estimated from the width of the detected face or the distance between the right and left eyes thereof, for example.

For example, the face detection portion recognizes the face of a person or a subject within a designated area of an imaged image, and determines based on the size of the face or the subject that the distance is long when the size of the face or subject is small, whilst the distance is short when the size of the face or subject is large.

According to the aforesaid embodiments relating to the operation of the extended screen in the terminal (“the dress-up PC” mounting the electronic paper on the rear surface side) having the plural screens, an operator can easily operates a screen not seen from the operation side, and the embodiment has the following features. First, as shown in FIGS. 6A and 6B, the small window application capable of displaying and operating the screen of the rear surface display is provided. Further, when the window is moved within the small-window application by a drag and drop operation, the window is seen as if it is moved to the small window side. In fact, the window is moved to the rear surface window side. Further, as shown in FIG. 7, the processing as to the respective operations are mounted so that the operations (click input, key input etc.) of the rear surface display can be performed by the small-window application. Further, a button is provided for the small-window application so that the display can be switched easily between the front surface/ rear surface displays. At the time of performing the switching, although originally the small-window application is displayed on the rear surface display side, the small-window application is rendered to reside on the front surface display side.

The normal liquid crystal display is mounted on the front surface side and the electronic paper display is mounted on the rear surface side. Since the display on the rear surface side is the electronic paper, an amount of the power consumption is small except for the image switching timing. The display on the rear surface side can be utilized, for example, as “the dress-up” display for displaying a design, a picture or characters etc. preferred by a person as shown in FIG. 4 or “the extended display” for showing as a projector to an opposed person as shown in FIG. 5. In the case of utilizing as the extended display, at the time of performing a Clone display, there arises no problem in the operation since the same image is displayed on each of the front surface/rear surface displays. Further, a problem, that operability is not good since an operator can not directly see the rear surface side display at the time of performing a conventional Extend display, is solved.

This invention is not limited to the aforesaid embodiments and can be implemented by modifying the embodiments in various manners in a range not departing from the gist thereof.

Further, various kinds of inventions can be formed by suitably combining the plural constituent elements disclosed in the aforesaid embodiments. For example, some of the constituent elements may be deleted from all the constituent elements disclosed in each of the embodiments. Furthermore, the constituent elements relating to the different embodiments may be suitably combined.

1. An electronic device comprising a first display and a second display, comprising:
a display controller configured to display a first image on the second display and display a second image and the first image superimposed on the second image on the first display;
an input receiver configured to receive an operation input with respect to the first image displayed on the first display; and
a processor configured to execute a first processing routine based on the operation input received by the input receiver.

2. The electronic device according to claim 1, wherein
the first display is a front surface display and the second display is a rear surface display.

3. The electronic device according to claim 1, wherein the operation input is movement of a window.

4. The electronic device according to claim 1, wherein
the operation input is a click or key input.

5. The electronic device according to claim 1, further comprising:
A dress-up display configured to display a dress-up screen on the second display.

6. The electronic device according to claim 1, wherein
the second display is an electronic paper display.

7. A display method in an electronic device comprising a first display and a second display, comprising:
displaying a first image on the second display and displaying a second image and the first image superimposed on the second image on the first display;
receiving an operation input with respect to the first image displayed on the first display; and
executing a first processing routine based on the operation input received by the input receiver.
